(19) United States
(12) Patent Application Publication
(10) Pub. No.: US 2012/0291635 A1
(43) Pub. Date: Nov. 22, 2012

(54) AUTOMATIC BREAD MAKER

(76) Inventors: Yasuyuki Ito, Tottori-shi (JP); Yoshinari Shirai, Tottori-shi (JP); Syuji Fukuda, Tottori-shi (JP)

(21) Appl. No.: 13/521,830

(22) PCT Filed: Feb. 14, 2011
(86) PCT No.: PCT/JP2011/052986

§ 371 Date: Jul. 12, 2012

(30) Foreign Application Priority Data
Feb. 24, 2010 (JP) 2010-038691

(51) Int. Cl. A47J 37/01; A21B 1/40; B02C 9/02; A21C 1/00

(52) U.S. Cl. 99/325; 99/538; 99/348

(57) ABSTRACT

An automatic bread maker (1) comprises: a bread container (not shown) into which bread ingredients are put; a body (10) having an accommodation part (30) for accommodating the bread container; a grinding blade (not shown) for grinding cereal grains inside the bread container accommodated in the accommodation part (30); and a duct (16) and fan (17) for creating an airflow for cooling the accommodation part (30) using ventilation holes (32, 33) provided to the accommodation part (30).

### TECHNICAL FIELD

The present invention relates to an automatic bread maker used mainly in typical households.

### BACKGROUND ART

Automatic bread makers for home use on the market generally have a system to make bread in which a bread container, into which the bread ingredients are put, is used as the baking pan (e.g., refer to Patent Document 1). In such an automatic bread maker, a bread container into which bread ingredients have been put is first introduced into a baking compartment in the body. The bread ingredients in the bread container are subsequently kneaded into a dough using a kneading blade provided in the bread container (kneading step). A fermentation step is then performed to ferment the kneaded dough, and the bread is baked using the bread container as the baking pan (baking step).

Conventionally, flour (wheat flour, rice flour, and the like) produced by milling a cereal such as wheat and rice, or mixed flour produced by mixing various supplementary ingredients into the milled flour, are required as bread-making ingredients when bread is made using such an automatic bread maker.

### LIST OF CITATIONS

### Patent Documents

[Patent Document 1] Japanese Laid-open Patent Application No. 2000-116526

### SUMMARY OF INVENTION

### Technical Problem

In typical households, a cereal is sometimes stored in a granular form, as with rice grain, instead of a powdered form. Therefore, it would be extremely convenient if it were possible to make bread directly from cereal grains using an automatic bread maker Accordingly, after diligent study the present applicants have invented a method for making bread using cereal grains as a starting ingredient. The present applicants have already submitted a patent application (Japanese Published Unexamined Application No. 2008-201507).

The bread-making method for which an application has already been submitted will be introduced. In this bread-making method, cereal grains are first mixed with a liquid, the grinding blade is caused to rotate in the mixture, and the cereal grains are ground (grinding step). Then gluten, yeast and other ingredients, for example, are fed into the paste-form ground flour obtained from the grinding step, and these bread ingredients are kneaded into a dough by a kneading blade (kneading step). After the dough is fermented (fermentation step), the fermented dough is baked into bread (baking step).

In order to realize an automatic bread maker that can execute these bread-making steps, the present applicants have been involved in developing an automatic bread maker that can execute the grinding step and the kneading step in a single bread container accommodated in the baking compartment. In the grinding step, the grinding blade is caused to rotate at high speed (e.g., 7000 to 8000 rpm) inside the bread container to make ground flour from cereal grains. In the kneading step, the kneading blade is caused to rotate at low speed (e.g., about 180 rpm) inside the bread container and the bread ingredients including the cereal grains ground in the grinding step are kneaded into bread dough.

During the development of the automatic bread maker, it was found that the temperature of the bread ingredients in the bread container readily increases excessively due to the frictional heat produced by the bearings or the like in the case that the grinding blade has been caused to rotate at high speed, and due to frictional heat between the grinding blade and the cereal grains. In the kneading step performed subsequent to the grinding step, a state in which the temperature of the bread ingredients has increased excessively is not preferred in consideration of causing the yeast to actively work. Therefore, there is a desire for the automatic bread maker being developed to be provided with a system that can inhibit an excessive increase in the temperature of the bread ingredients in the grinding step.

In view of the foregoing, an object of the present invention is to provide an automatic bread maker that can make bread from cereal grains and that can inhibit an increase in the temperature of the bread ingredients that accompanies the grinding of the cereal grains.

### Solution to Problem

In order to achieve the aforementioned object, an automatic bread maker according to the present invention comprises: a bread container into which bread ingredients are put; a body having an accommodation part for accommodating the bread container; a grinding blade for grinding cereal grains inside the bread container accommodated in the accommodation part; and a duct and fan for creating an airflow for cooling the accommodation part using ventilation holes provided in the accommodation part.

The automatic bread maker of the present aspect is provided with a grinding blade and is capable of making bread from cereal grains. The automatic bread maker of the present aspect has a configuration further comprising a duct and fan for creating an airflow for cooling the accommodation part. It is possible to inhibit an excessive increase in the temperature of the bread ingredients in the bread container accommodated in the accommodation part in the case that cereal grains are ground using the grinding blade.

The automatic bread maker of the aspect described above preferably further comprises a first motor provided inside the body in order to cause the grinding blade to rotate. In this aspect, the first motor is driven in the case that cereal grains are to be ground. The first motor causes the grinding blade to rotate at high speed, and frictional heat produced by the bearings or the like by driving the first motor readily increases the temperature of the bread ingredients. In view whereof, in the present aspect, an excessive increase in the temperature of the bread ingredients can be inhibited because a duct and fan are provided for creating an airflow that cools the accommodation part.

The automatic bread maker of the aspect described above may further comprises a control unit for executing bread-making steps, the bread-making steps including a grinding step for causing the grinding blade to rotate and grind cereal grains inside the bread container into which cereal grains and a liquid have been put, wherein the control unit drives the fan in the case that the grinding step is executed. In accordance with the present aspect, the driving of the fan is controlled by the control unit during the grinding step and is therefore convenient for the user.

The automatic bread maker of the aspect described above may further comprise: a kneading blade for kneading bread ingredients into bread dough inside the bread container accommodated in the accommodation part; a second motor provided inside the body in order to cause the kneading blade to rotate; a heating part provided to the accommodation part; and a control unit for causing bread-making steps to be executed, the bread-making steps including a grinding step for causing the grinding blade to rotate and grind cereal grains inside the bread container into which cereal grains and a liquid have been put, a kneading step for causing the kneading blade to rotate and knead bread dough inside the bread container into which bread ingredients including ground flour obtained by grinding cereal grains have been put, a fermentation step for causing kneaded bread dough to ferment, and a baking step for baking the fermented bread dough, wherein the control unit drives the fan in the case that at least the grinding step of the bread-making steps is executed.

In accordance with the present aspect, driving of the fan during at least the grinding step is controlled by the control unit and is therefore convenient for the user.

The automatic bread maker of the aspect described above may further comprise: a temperature detector for detecting the temperature of the accommodation part; and a control unit for controlling drive of the fan on the basis of temperature information obtained from the temperature detector. Such a configuration makes it possible to drive the fan with suitable timing in consideration of the effect of ambient temperature (e.g., it is possible to drive the fan with suitable timing in the kneading step or the like as well, and not merely in the grinding step). The automatic bread maker of the present aspect can therefore readily make good quality bread.

In the automatic bread maker of the above-described aspect, the ventilation holes may be formed so that a part of a sidewall of the accommodation part is made to protrude in a direction facing the exterior of the accommodation part. In accordance with the present aspect, it is possible to adopt a configuration in which foreign matter is unlikely to enter from the accommodation part into the interior of the body and the interior of the duct via the ventilation holes. Also, in accordance with present aspect, it is possible to achieve a configuration in which there will be little incidence of matter getting caught or other such events occurring inside the accommodation part because projections are not formed inside the accommodation part.

In the automatic bread maker of the aspect described above, first ventilation holes and second ventilation holes may be included in the ventilation holes provided to the accommodation part; the accommodation part and the exterior of the body may be in communication via the duct and the second ventilation holes; and the fan may take air from the exterior of the accommodation part into the accommodation part via the first ventilation holes, and exhaust air inside the accommodation part to the exterior of the body via the second ventilation holes and the duct. In accordance with the present aspect, a cooling mechanism using a fan and a duct is readily achieved at low cost.

In the automatic bread maker of the aspect described above, the first ventilation holes may be formed in a first sidewall of the accommodation part, the second ventilation holes may be formed in a second sidewall of the accommodation part, and the first sidewall and the second sidewall may face each other. In accordance with the present aspect, a configuration is adopted wherein an intake port (first ventilation holes) and an exhaust port (second ventilation holes) are provided so that the bread container accommodated inside the accommodation part is disposed therebetween, and the bread container is readily cooled with good efficiency by the airflow created by the fan.

In the automatic bread maker of the aspect described above, the fan is preferably provided inside the duct. The present aspect makes it possible to reduce the size of the automatic bread maker. Also, the fan is not exposed on the exterior side, and a safe automatic bread maker can be obtained.

### Advantageous Effects of the Invention

In accordance with the present invention, it is possible to provide an automatic bread maker that can make bread from cereal grains and that can inhibit an increase in the temperature of the bread ingredients that accompanies the grinding of the cereal grains. In other words, in accordance with the present invention, an automatic bread maker provided with a convenient system capable of making bread from cereal grains can be provided, and it can therefore be expected that bread-making at home will become more accessible and popular.

### BRIEF DESCRIPTION OF THE DRAWINGS

FIG. 1 is a schematic perspective view showing a configuration of the external appearance of the automatic bread maker according to the present embodiment;

FIG. 2 is an illustrative diagram showing the configuration inside the body of the automatic bread maker of the present embodiment;

FIG. 3A is a diagram illustrating the clutch included in the first power transmission unit provided to the automatic bread maker of the present embodiment, and is a diagram showing the state in which the clutch cuts off power;

FIG. 3B is a diagram illustrating the clutch included in the first power transmission unit provided to the automatic bread maker of the present embodiment, and is a diagram showing the state in which the clutch transmits power;

FIG. 4 is a partial cross-sectional view showing the schematic configuration of the automatic bread maker of the present embodiment;

FIG. 5 is a view for illustrating a configuration of a grinding blade and a kneading blade provided to the automatic bread maker according to the present embodiment, and is a schematic view observed diagonally from the below;

FIG. 6 is a view for illustrating the configuration of the grinding blade and the kneading blade provided to the automatic bread maker of the present embodiment, and is a schematic view observed from the bottom;

FIG. 7 is a top view of the bread container in the automatic bread maker according to the present embodiment when the kneading blade is in the folded orientation;

FIG. 8 is a top view of the bread container in the automatic bread maker according to the present embodiment when the kneading blade is in the open orientation;

FIG. 9 is a schematic perspective view showing a configuration of the guard provided to the automatic bread maker of the present embodiment;

FIG. 10 is a view for illustrating a configuration of the cooling mechanism provided to the automatic bread maker of the present embodiment;

FIG. 11 is a block diagram showing the configuration automatic bread maker of the present embodiment; and

FIG. 12 is a schematic view showing the flow of the bread-making steps executed by the rice-grain bread-making procedure.

### DESCRIPTION OF EMBODIMENTS

Embodiments of an automatic bread maker according to the present invention will be described in detail below with reference to the accompanying drawings. It is to be understood that any specific time, temperature, or other parameters that appear in this specification are merely examples and are not intended in any way to limit the content of the invention.

(Configuration of the Automatic Bread Maker)

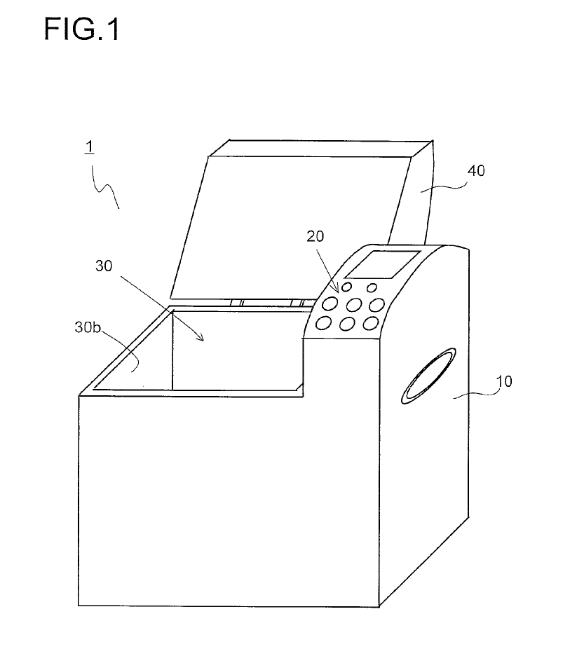

FIG. 1 is a schematic perspective view showing a configuration of the external appearance of the automatic bread maker according to the present embodiment. An operation part 20 is provided on the right side of the upper surface of the body 10 (formed from, e.g., plastic) of the automatic bread maker 1, as shown in FIG. 1. The operation part 20 is provided with an operation key group comprising, inter alia, a start key, a cancel key, a timer key, a reservation key, and a selection key for selecting a bread-making procedure; and a display unit for displaying the contents of a setup performed by operating the operation keys, errors, and other data. The bread-making procedures described above includes a procedure for making bread using rice grains as a starting ingredient, a procedure for making bread using rice flour as a starting ingredient, a procedure for making bread using wheat flour as a starting ingredient, and other procedures. Also, the display unit is composed of, e.g., a liquid crystal display panel, and indicator lamps using light emitting diodes as light sources.

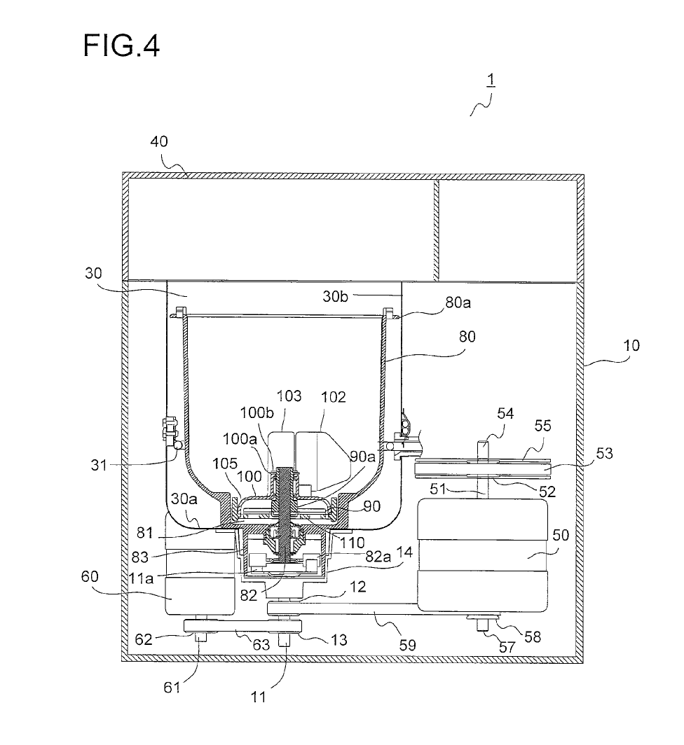

A baking compartment 30 (an embodiment of the accommodation part of the present invention) for accommodating the bread container (described in detail below) is formed in the body 10 so as to be adjacent to the operation part 20 (next to the left side thereof in FIG. 1). The baking compartment 30 made of, e.g., sheet metal is formed in substantially a rectangular shape as view from above, has a bottom wall 30a and four sidewalls 30b (refer also to FIG. 4 described below), and has an open upper surface. A lid 40 (made of, e.g., plastic) for covering the baking compartment 30 is provided to the body 10. The lid 40 is mounted on the back surface of the body 10 using a hinge (not shown). The lid 40 is swung about the hinge as a support point, whereby the aperture of the baking compartment 30 can be opened and closed. The lid 40 is provided with an observation window (not shown) made of, e.g., heat-resistant glass to allow the user to view the baking compartment 30.

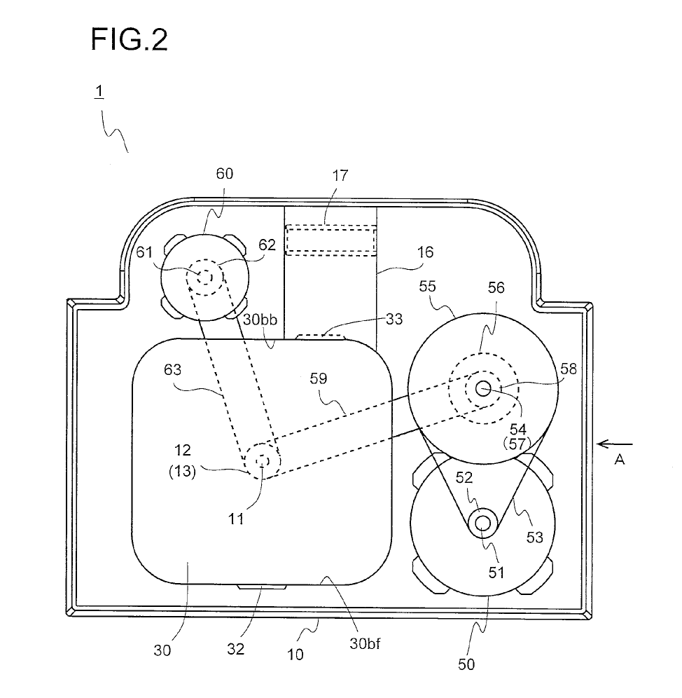

FIG. 2 is an illustrative diagram showing the configuration inside the body of the automatic bread maker of the present embodiment. FIG. 2 envisions the case in which the automatic bread maker 1 is viewed from above. A low-speed, high-torque kneading motor 50 used in the kneading step is secured and disposed to the right of the baking compartment 30 in the automatic bread maker 1, as shown in FIG. 2. A high-speed-rotation grinding motor 60 used in the grinding step is disposed and secured behind the baking compartment 30 in the automatic bread maker 1. The kneading motor 50 and the grinding motor 60 both have vertically oriented shafts. The kneading motor 50 is an embodiment of the second motor of the present invention, and the grinding motor 60 is an embodiment of the first motor of the present invention.

A first pulley 52 is secured to an output shaft 51 that protrudes from the upper surface of the kneading motor 50. The first pulley 52 is connected to a second pulley 55 by a first belt 53. The second pulley 55 is formed having a greater diameter than the first pulley 52 and is secured to the upper side of the first rotating shaft 54. A second rotating shaft 57 is provided to the lower side of the first rotating shaft 54 so that the rotational center is substantially the same as that of the first rotating shaft 54. The first rotating shaft 54 and the second rotating shaft 57 are rotatably supported inside the body 10. A clutch 56 for transmitting and interrupting power is provided between the first rotating shaft 54 and the second rotating shaft 57. The configuration of the clutch 56 will be described later.

A third pulley 58 is secured to the lower side of the second rotating shaft 57. The third pulley 58 is connected to a first motor shaft pulley 12 (having substantially the same diameter as the third pulley 58) by a second belt 59. The first motor shaft pulley 12 is secured to a motor shaft 11 which is provided to the lower side of the baking compartment 30. The kneading motor 50 is a low-speed, high-torque motor, and the rotation of the first pulley 52 thereabove is reduced by the second pulley 55 (e.g., reduced to ⅕ speed). Accordingly, the motor shaft 11 rotates at low speed when the kneading motor 50 is driven in a state in which the clutch 56 is transmitting power.

The power transmission unit configured using the first pulley 52, the first belt 53, the first rotating shaft 54, the second pulley 55, the clutch 56, the second rotating shaft 57, the third pulley 58, the second belt 59, and the first motor shaft pulley 12 is at times referred to below as a first power transmission unit. The first power transmission unit connects the motor shaft 11 and the output shaft 51 of the kneading motor 50 in a power-transmission-enabled manner in a state in which the clutch 56 is performing power transmission.

A fourth pulley 62 is secured to an output shaft 61 that protrudes from the lower surface of the grinding motor 60. The fourth pulley 62 is connected to a second motor shaft pulley 13 (secured further below the first motor shaft pulley 12) which is secured to the motor shaft 11 by a third belt 63. The second motor shaft pulley 13 has substantially the same diameter as the fourth pulley 62. A high-speed motor is selected as the grinding motor 60 and the rotation of the fourth pulley 62 is kept at substantially the same speed as the second motor shaft pulley 13. Accordingly, the motor shaft 11 rotates at high speed (e.g., 7000 to 8000 rpm) when the grinding motor 60 is driven.

The power transmission unit composed of the fourth pulley 62, the third belt 63, and the second motor shaft pulley 13 may hereinbelow be referred to as a second power transmission unit. The second power transmission unit is of a clutchless configuration, and the motor shaft 11 and the output shaft 61 of the grinding motor 60 are connected so as to allow constant power transmission.

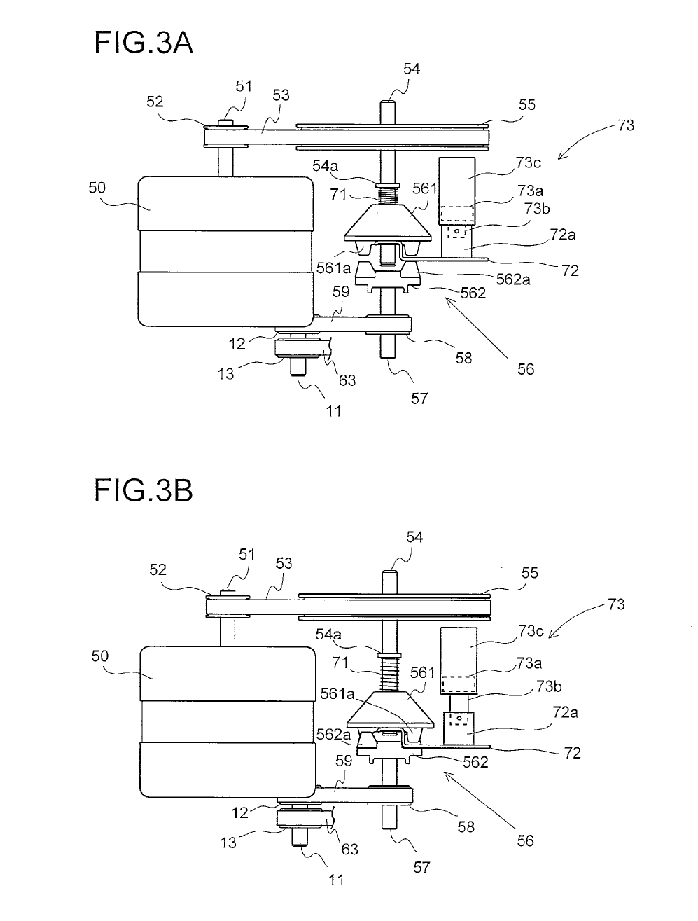

FIGS. 3A and 3B are diagrams illustrating the clutch included in the first power transmission unit provided to the automatic bread maker of the present embodiment. FIGS. 3A and 3B are views of the first power transmission unit as viewed along the A direction of the arrow in FIG. 2. FIG. 3A shows the state in which the clutch 56 cuts off power, and FIG. 3B shows the state in which the clutch 56 transmits power.

The clutch 56 has a first clutch member 561 and a second clutch member 562, as shown in FIGS. 3A and 3B. The clutch 56 transmits power in the case that a pawl 561a provided to the first clutch member 561 meshes with a pawl 562a provided to the second clutch member 562 (the state shown in FIG. 3B). The clutch 56 cuts off power in the case the two pawls 561a, 562b do not mesh together (the state shown in FIG. 3A). In other words, the clutch 56 is a meshing clutch.

In the present embodiment, six pawls 561a, 562a aligned in the peripheral direction in substantially equidistant intervals are provided to the two clutch members 561, 562, but the number of pawls can be suitably modified. Here, the peripheral direction refers to the case in which the first clutch member 561 is viewed from below and the case in which the second clutch member 562 is viewed from above. An advantageous shape of the pawls 561a, 562a can be suitably selected.

The first clutch member 561 is retainably arranged, the first clutch member 561 being capable of sliding in the axial direction (the vertical direction in FIGS. 3A and 3B) of the first rotating shaft 54, and being mounted thereon so as to be incapable of rotation. A spring 71 is loosely fitted on the upper side of the first clutch member 561 in the first rotating shaft 54. The spring 71 is arranged so as to be sandwiched between the first clutch member 561 and a stopper 54a provided to the first rotating shaft 54, and so as to urge the first clutch member 561 downward. The second clutch member 562 is secured to the upper end of the second rotating shaft 57.

Switching (switching between a power transmission state and a power cutoff state) of the clutch 56 is carried out using an arm part 72 disposed below the first clutch member 561 and movably provided in the vertical direction (axial direction of the first rotating shaft 54), and a self-holding solenoid 73 in which a permanent magnet 73a is housed. The distal end part (corresponding to the lower side in FIGS. 3A and 3B) of a plunger 73b of the solenoid 73 is secured to the mounting part 72a provided to the arm part 72. The arm part 72 (including the mounting part 72a) is formed using metal and can therefore chuck to the permanent magnet 73a.

The force by which the permanent magnet 73a chucks the arm part 72 (more precisely, the mounting part 72a) is reduced when voltage is applied to the solenoid 73 so as to cancel the magnetic field of the permanent magnet 73a from the state shown in FIG. 3A. The first clutch member 561 is pressed downward by the urging force of the spring 71. Meshing is thereby obtained between the pawl 561a of the first clutch member 561 and the pawl 562a of the second clutch member 562, and the clutch 56 transmits power (achieving the state shown in FIG. 3B). The state in which this meshing has been achieved is maintained by the urging force of the spring 71, the driving for bringing the first clutch member 561 downward is therefore carried out, and the solenoid 73 is switched off. In this state in which meshing has been achieved, the arm part 72 is lowered and the plunger 73b of the solenoid 73 is therefore in a state in which the protruding distance (downward protruding distance) from a housing 73c has been increased.

On the other hand, when voltage is applied to the solenoid 73 in a direction that lifts the plunger 73b from the state shown in FIG. 3B (voltage in the direction opposite from the direction for canceling the magnetic field of the permanent magnet 73a), the first clutch member 561 is lifted upward together with the arm part 72 against the urging force of the spring 71. Meshing is thereby released between the pawl 561a of the first clutch member 561 and the pawl 562a of the second clutch member 562, and the clutch 56 cuts off power (achieving the state shown in FIG. 3A). In a state in which this meshing has been released, the permanent magnet 73a housed in the solenoid 73 chucks the arm part 72 (more precisely, the mounting part 72a). Therefore, after the driving for lifting the first clutch member 561 has been carried out, the state in which the meshing has been release can be maintained even if the solenoid 73 is switched off, and the solenoid 73 is then switched off.

In the case that the grinding motor 60 is to be driven, the rotary power for causing the motor shaft 11 to rotate at high speed is transmitted to the output shaft 51 of the kneading motor 50 when the clutch 56 is in a power-transmitting state (the state shown in FIG. 3B). In this case, a force for causing the output shaft 51 of the kneading motor 50 to rotate at 40,000 rpm is required in accordance with the radius ratio between the first pulley 52 and the second pulley 55 (e.g., 1:5) when the grinding motor 60 is to be caused to rotate at, e.g., 8000 rpm. As a result, the grinding motor 60 may be damaged because an extremely high load is imparted to the grinding motor 60. The rotary power for causing the motor shaft 11 to rotate at high speed must be kept from being transmitted to the output shaft 51 of the kneading motor 50 when the grinding motor 60 is driven, and the automatic bread maker 1 therefore has a configuration that includes the clutch 56 for performing power transmission and power cutoff in the first power transmission unit.

As described above, the automatic bread maker has a configuration in which a clutch is not provided to the second power transmission unit, which is composed of the fourth pulley 62, the third belt 63, and the second motor shaft pulley 13. However, even with such a configuration, a high load such as that described above is not applied to the kneading motor 50 and motor damage does not occur. This is due to the fact that the motor shaft 11 is rotated merely at low speed (e.g., 180 rpm) even when the kneading motor 50 is driven, and a high load is not applied to the kneading motor 50 even if the rotary power for causing the motor shaft 11 to rotate is transmitted to the output shaft of the grinding motor 60. Also, the cost of manufacturing the automatic bread maker is reduced by using a configuration in which a clutch is not specially provided to the second power transmission unit in this manner.

In the automatic bread maker 1 of the present embodiment, the clutch 56 is a meshing clutch, but the present invention shall not be construed to be limited thereby; in some cases, it is also possible to use an electromagnetic clutch or the like in place of a meshing clutch.

FIG. 4 is a partial cross-sectional view showing the schematic configuration of the automatic bread maker of the present embodiment. FIG. 4 envisions the case in which the automatic bread maker is viewed from the front. In FIG. 4, the bread container 80 into which bread ingredients have been put is shown in a state accommodated in the baking compartment 30. A sheath heater 31 (an embodiment of the heating part of the present invention) is disposed inside the baking compartment 30 so as to surround the bread container 80 accommodated in the baking compartment 31, as shown in FIG. 4. The bread ingredients inside the bread container 80 can thereby be heated.

A bread container support 14 (made of, e.g., a die-cast article molded from an aluminum alloy) for supporting the bread container 80 is secured at a location corresponding substantially to the center of the bottom wall 30a of the baking compartment 30. The bread container support 14 is formed so as to be depressed from the bottom wall 30a of the baking compartment 30, and the shape of the depression is substantially circular as viewed from above. The motor shaft 11 is supported in the center of the bread container support 14 so as to be substantially vertical with respect to the bottom wall 30a.

The bread container 80 is, e.g., a die-cast molding of an aluminum alloy. The bread container 80 has the shape of a bucket and a handle (not shown) for gripping is mounted on a flange part 80a provided to edge of the aperture of the bread container. The horizontal cross-section of the bread container 80 is a rectangle with four rounded corners. A recess 81 having a substantially circular shape as viewed from above is formed in the bottom part of the bread container 80 to accommodate a grinding blade 90 (described in detail hereafter) and a cover 100.

A vertically extending blade rotation shaft 82 is rotatably supported in a sealed state at the center of the bottom part of the bread container 80. A container-side coupling member 82a is secured to the lower end of the blade rotation shaft 82 (the lower end protrudes from the bottom part of the bread container 80). A cylindrical pedestal 83 is provided to the exterior surface side of the bottom part of the bread container 80, and the bread container 80 is designed to be accommodated in the baking compartment 30 in a state in which the pedestal 83 is received by the bread container support 14. The pedestal 83 may be formed separately from the bread container 80 or may be integrally formed with the bread container 80.

Projections (not shown) are formed on the internal circumferential surface of the bread container support 14 and the external circumferential surface of the pedestal 83, and these projections constitute a known bayonet coupling. In other words, when the bread container 80 is to be mounted on the bread container support 14, the projections on the pedestal 83 are kept from interfering with the projections on the bread container support 14, and the bread container 80 is lowered thereon. After the pedestal 83 is fitted into the bread container support 14, the projections of the pedestal 83 are designed to engage with the lower surfaces of the projections of the bread container support 14 when the bread container 80 twists horizontally. The bread container 80 is thereby prevented from slipping out upwards.

With this operation, the connecting (coupling) of the above-described container-side coupling member 82a provided to the lower end of the blade rotation shaft 82 and a motor shaft-side coupling member 11a secured to the upper end of the motor shaft 11 is also achieved at the same time. This coupling makes it possible for rotary power from the motor shaft 11 to be transmitted to the blade rotation shaft 82.

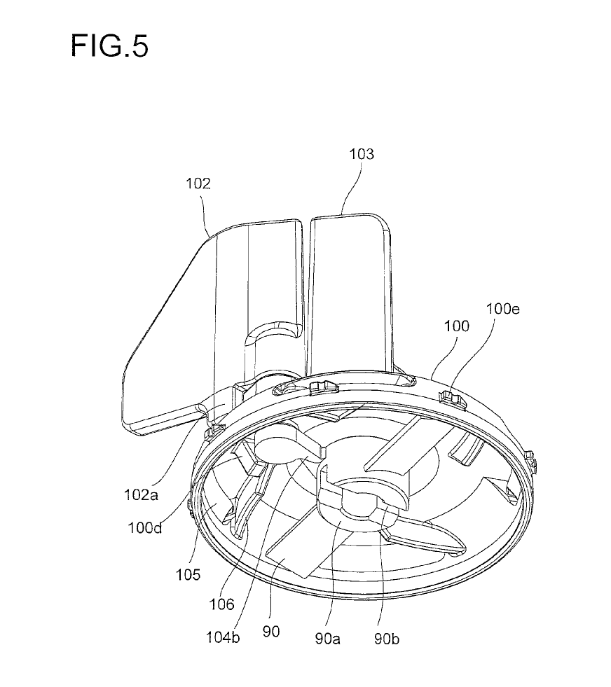

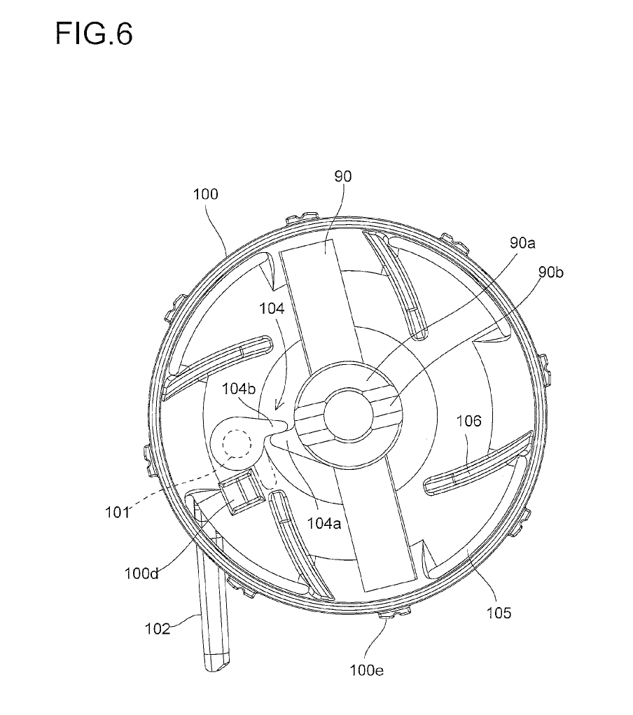

The grinding blade 90 is mounted on the blade rotation shaft 82 at a location slightly above the bottom of the bread container 80. A dome-shaped cover 100 having a substantially circular shape as viewed from above is mounted on the upper end of the blade rotation shaft 82. FIG. 5 is a view for illustrating a configuration of a grinding blade and a kneading blade provided to the automatic bread maker of the present embodiment, and is a schematic view observed diagonally from the below. FIG. 6 is a view for illustrating a configuration of a grinding blade and a kneading blade provided to the automatic bread maker of the present embodiment, and is a schematic view observed from the below.

The grinding blade 90 (formed from, e.g., a stainless steel plate) has a shape similar to an aircraft propeller and is mounted so as to be incapable of rotation in relation to the blade rotation shaft 82, as shown in FIGS. 5 and 6. The center part of the grinding blade 90 is a hub 90a that fits onto the blade rotation shaft 82. A groove 90b is formed in the lower surface of the hub 90a so as to traverse the hub 90a in the diameter direction. In the case that the grinding blade 90 is fitted onto the blade rotation shaft 82 from above, a pin (not shown) that passes through the blade rotation shaft 82 in the horizontal direction receives the hub 90a and engages the groove 90b. The grinding blade 90 is connected mounted to the blade rotation shaft 82 so as to be unable to rotate.

The grinding blade 90 is configured so that it can be readily pulled away and separated from the blade rotation shaft 82, and can therefore be cleaned after bread making and can be readily replaced when the edge thereof becomes dull.

A dome-shaped cover 100 (made of, e.g., a die-cast molding of an aluminum alloy) surrounds, covers, and hides the grinding blade 90, as shown in FIG. 5. The cover 100 is rotatably supported by the hub 90a of the grinding blade 90 and is retained on the hub 90a by a washer 100a and a retaining ring 100b (refer to FIG. 4). In other words, in the present embodiment, the grinding blade 90 and the cover 100 constitute an inseparable unit. The hub 90a of the grinding blade 90 is configured so as to double as a rotating shaft receiving part for receiving the blade rotation shaft 82 in the cover 100.

The cover 100 can be easily pulled away from the blade rotation shaft 82 together with the grinding blade 90, enabling cleaning to be readily performed after making bread.

A kneading blade 102 (made of, e.g., a die-cast molding of an aluminum alloy), whose planar shape is a sideways V, is mounted on the exterior surface of the dome-shaped cover 100, and is mounted on a support shaft 101 (refer to FIG. 6) that extends in the vertical direction in a location set at a distance from the blade rotation shaft 82. The support shaft 101 is fixed to or integrated with the kneading blade 102 and moves with the kneading blade 102.

In the present embodiment, a complementary kneading blade 103 is provided to the exterior surface of the cover 100 so as to align with the kneading blade 102. The complementary kneading blade 103 is not necessarily required, but is preferably provided in order to increase efficiency in the kneading step for kneading bread dough. In the case of the present configuration, the kneading blade 102 and the complementary kneading blade 103 are an embodiment of the kneading blade of the present invention.

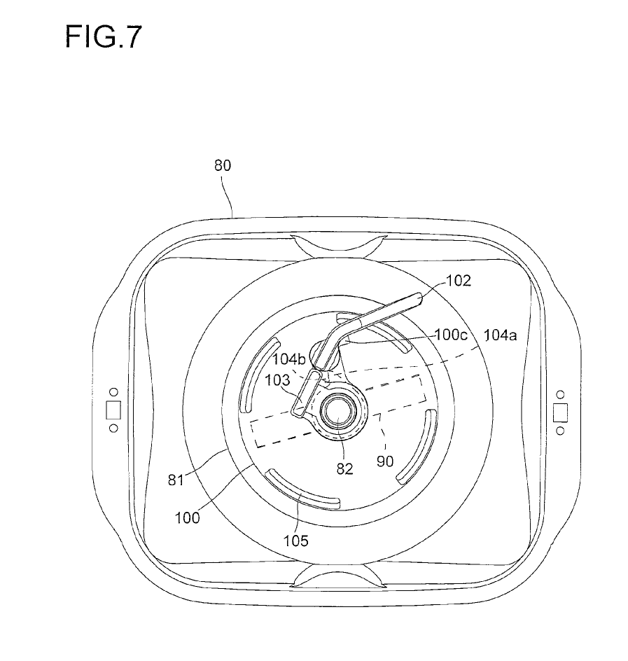

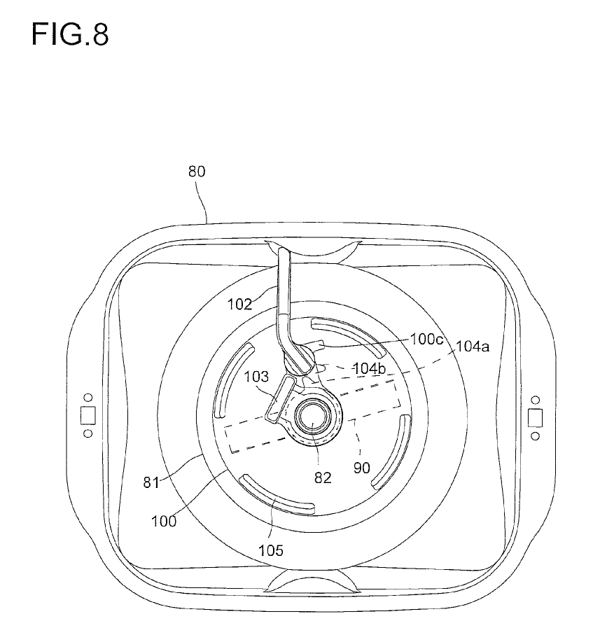

The operation of the kneading blade 102 will be described with reference to FIGS. 5 to 8. FIGS. 7 and 8 are a view of the bread container 80 as seen from above, and the kneading blade 102 has a different orientation in FIGS. 7 and 8.

The kneading blade 102 rotates together with the support shaft 101 about the axis of the support shaft 101, and has two orientations: the folded orientation shown in FIG. 7, and the open orientation shown in FIG. 8. In the folded orientation, a projection 102a (refer to FIG. 5) suspended downward from the lower edge of the kneading blade 102 is in contact with a first stopper 100c provided to the upper surface of the cover 100. Accordingly, in the folded orientation, the kneading blade 102 cannot swing further in the clockwise direction (when viewed from above) in relation to the cover 100. At this time, the tip of the kneading blade 102 protrudes slightly from the cover 100. When the kneading blade 102 swings from this orientation in the counterclockwise direction (as viewed from above) and achieves the orientation shown in FIG. 8, the distal end of the kneading blade 102 protrudes considerably from the cover 100. The open angle of the kneading blade 102 in the open orientation is limited by a second stopper 100d (refer to FIGS. 5 and 6) provided to the interior surface of the cover 100. The kneading blade 102 is at the maximum open angle when a second engaging body 104b (which is securely mounted on the support shaft 101) constituting a later-described cover clutch 104 (refer to FIG. 6) makes contact with the second stopper 100d and can no longer rotate.

In the case that the kneading blade 102 is in the folded orientation, the complementary kneading blade 103 is aligned with the kneading blade 102 as shown in FIG. 7, and the size of the kneading blade 102 essentially having the shape of a sideways V is increased.

As shown in FIG. 6, the cover clutch 104 is interposed between the cover 100 and the blade rotation shaft 82. The cover clutch 104 connects the blade rotation shaft 82 and the cover 100 in the rotation direction of the blade rotation shaft 82 when the kneading motor 50 causes the motor shaft 11 to rotate (this rotation direction is the “forward direction,” and is the clockwise direction in FIG. 6). Conversely, the cover clutch 104 disconnects the blade rotation shaft 82 from the cover 100 in the rotation direction of the blade rotation shaft 82 when the grinding motor 60 causes the motor shaft 11 to rotate (this rotation direction is the “reverse direction,” and is the counter-clockwise direction in FIG. 6). In FIGS. 7 and 8, the “forward direction rotation” is the counter-clockwise direction rotation and the “reverse direction rotation” is the clockwise direction rotation.

The cover clutch 104 will be described in further detail. The cover clutch 104 is composed of a first engaging body 104a and the second engaging body 104b. The first engaging body 104a is secured to the hub 90a of the grinding blade 90 or is integrally formed with the hub 90a. In other words, the grinding blade 90 is mounted on the blade rotation shaft 82 and the first engaging body 104a is mounted on the blade rotation shaft 82 so as to be unable to rotate. The second engaging body 104b is secured to the support shaft 101 of the kneading blade 102 or integrally formed with the support shaft 101, and varies in angle in accompaniment with the change in orientation of the kneading blade 102.

In the case that the kneading blade 102 is in the folded orientation (e.g., the state of FIGS. 6 and 7), the second engaging body 104b is at an angle that interferes with the rotation trajectory of the first engaging body 104a. Therefore, the first engaging body 104a and the second engaging body 104b engage when the blade rotation shaft 82 rotates in the forward direction (rotation in the clockwise direction in FIG. 6, and rotation in the counter-clockwise direction in FIG. 7), and the rotary force of the blade rotation shaft 82 is transmitted to the cover 100 and the kneading blade 102.

On the other hand, in the case that the kneading blade 102 is in the open orientation (the state of FIG. 8), the second engaging body 104b is at an angle that does not interfere with the rotation trajectory of the first engaging body 104a. Therefore, even when the blade rotation shaft 82 rotates in the reverse direction (rotation in the clockwise direction in FIG. 8), the first engaging body 104a and the second engaging body 104b do not engage with each other. The rotary force of the blade rotation shaft 82 accordingly is not transmitted to the cover 100 and the kneading blade 102. It is apparent from the above that the cover clutch 104 switches the connection state between the blade rotation shaft 82 and the cover 100 using the orientation of the kneading blade 102.

A window 105 that provides communication between the interior space of the cover and the exterior space of the cover is formed in the cover 100, as shown in FIGS. 5 and 6. The window 105 is disposed at the same height as the grinding blade 90 or in a position thereabove. In the present embodiment, four windows 105 are arranged at 90° intervals, but any number and arrangement interval may be used.

Also, four ribs 106 are formed in corresponding fashion to the windows 105 on the interior surface of the cover 100. The ribs 106 extend diagonally in the radial direction from near the center of the cover 100 to the annular wall of the external periphery, and the four ribs together constitute a type of spiral shape. The ribs 106 curve so that the sides facing the bread ingredients, which are pressed toward the ribs, are convex.

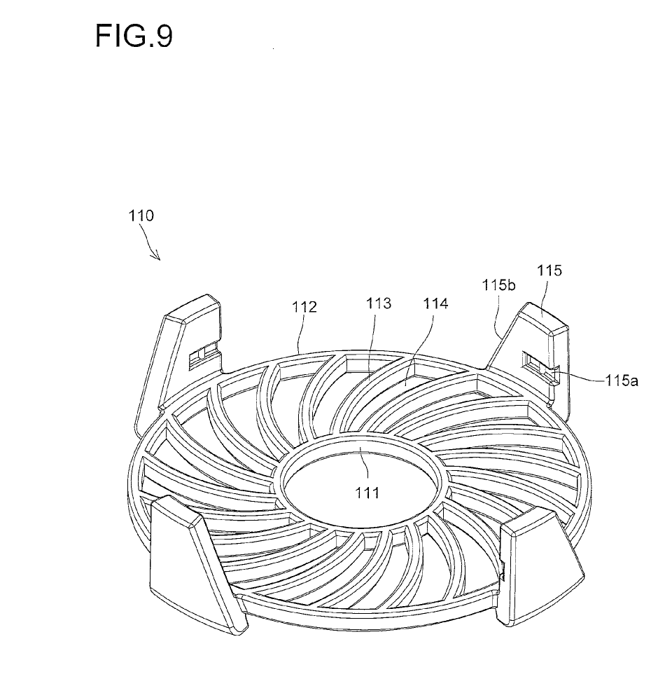

Returning to FIG. 4, a guard 110 is detachably mounted on the lower surface of the cover 100. The guard 110 covers the lower surface of the cover 100 and blocks the user's finger from coming near the grinding blade 90. The guard 110 is formed from, e.g., a heat resistant engineering plastic and is a molded article composed of, e.g., polyphenylene sulfide (PPS) or the like. FIG. 9 is a schematic perspective view showing a configuration of the guard provided to the automatic bread maker of the present embodiment.

A ring-shaped hub 111 for passing the blade rotation shaft 82 is provided in the center of the guard 110, as shown in FIG. 9. A ring-shaped rim 112 is provided to the peripheral edge of the guard 110. The hub 111 and the rim 112 are connected by a plurality of spokes 113. The spaces between the spokes 113 constitute an aperture part 114 for passing rice grains ground by the grinding blade 90. The size of the aperture part 114 is such that a finger cannot pass through.

The guard 110 is proximate to the grinding blade 90 when the guard has been mounted on the cover 100. The guard 110 has the appearance of an outer blade of a rotary electric shaver and the grinding blade 90 has the appearance of an inner blade.

Four columns 115 (no limitation is imposed on the number thereof, as shall be apparent) are integrally molded at 90° intervals at the peripheral edge of the rim 112. A horizontal groove 115a with a terminus at one end is formed on the side surface facing the center side of the guard 110 of the columns 115. Projections 100e (eight of these also are disposed at 45° intervals in the present embodiment) formed on the external periphery of the cover 100 engage the groove 115a, whereby the guard 110 is mounted on the cover 100. The groove 115a and the projections 100e are provided so as to constitute a bayonet coupling.

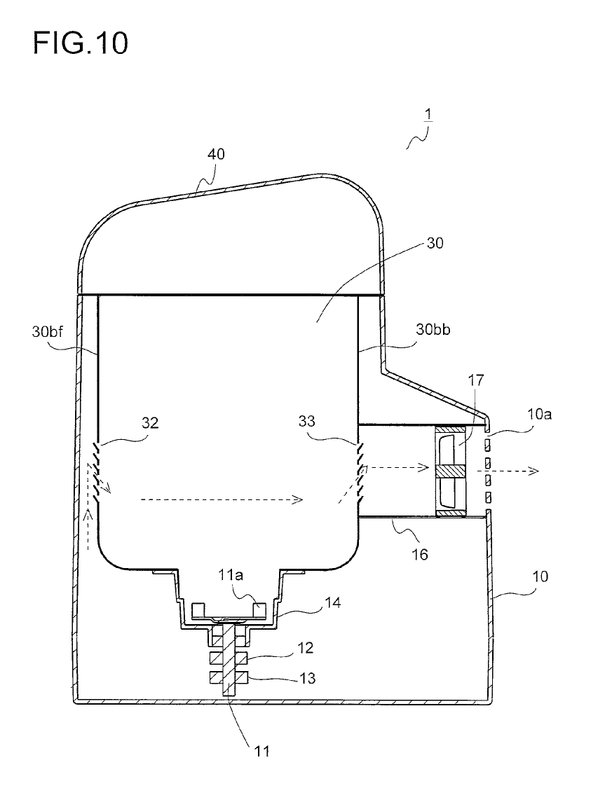

FIG. 10 is a view for illustrating a configuration of the cooling mechanism provided to the automatic bread maker of the present embodiment. FIG. 10 is a schematic cross-sectional view of the case in which the automatic bread maker 1 is viewed from the side surface, and shows the case in which the bread container 80 is not accommodated in the baking compartment 30. In FIG. 10, the left side of the diagram corresponds to the front surface side of the automatic bread maker 1, and the right side of the diagram corresponds to the rear surface side of the automatic bread maker 1.

A plurality of first ventilation holes 32 are formed in alignment in the depth direction in the front sidewall 30bf (an embodiment of the first sidewall of the present invention) of the baking compartment 30, as shown in FIG. 10 (refer also to FIG. 2). The first ventilation holes 32 are obtained by performing work in which a part of the front sidewall 30bf made of sheet metal is made to protrude in a direction facing the exterior of the baking compartment 30 (the left-side direction of FIG. 10). The first ventilation holes 32 are formed so that the upper part side of the portion protruding to the exterior of the baking compartment 30 is open, and a configuration is achieved wherein an air channel connecting to the interior of the baking compartment 30 is formed facing diagonally downward from the opening (diagonally downward to the right in FIG. 10).

A plurality of second ventilation holes 33 are formed in alignment in the depth direction in the rear sidewall 30bb (an embodiment of the second sidewall of the present invention) facing the front sidewall 30bf, as shown in FIG. 10 (refer also to FIG. 2). In the present embodiment, the number of second ventilation holes 33 is the same as the number of first ventilation holes 32, but the number is not required to be the same as the number of first ventilation holes 32. The second ventilation holes 33 are obtained by performing work in which a part of the rear sidewall 30bb made of sheet metal is made to protrude in a direction facing the exterior of the baking compartment 30 (the right-side direction of FIG. 10). The second ventilation holes 33 are formed so that the upper part side of the portion protruding to the exterior of the baking compartment 30 is open, and a configuration is achieved wherein an air channel connecting to the interior of the baking compartment 30 is formed facing diagonally downward from the opening (diagonally downward to the left in FIG. 10).

In the body 10, one end part of an angular duct 16 is mounted on the rear sidewall 30bb. The second ventilation holes 33 formed on the rear sidewall 30bb of the baking compartment 30 are covered and hidden from the exterior side of the baking compartment 30 by one end part of the angular duct 16. The other end part of the duct 16 is mounted on the body 10 so as to cover and hide a plurality of slit parts 10a from the interior side of the body 10, the slit parts 10a being provided to the back surface of the body 10. The duct 16 provided in this manner is configured to provide communication between the baking compartment 30 and the exterior of the body 10 via the second ventilation holes 33 and the slit parts 10a.

An axial-flow fan 17 is mounted inside the duct 16 in a position near the slit parts 10a. When the fan 17 is driven, air is taken from the exterior of the baking compartment 30 into the baking compartment 30 via the first ventilation holes 32, and air inside the baking compartment 30 is exhausted to the exterior of the body 10 via the second ventilation holes 33 and the duct 16, as shown by the broken arrow in FIG. 10. In other words, an air flow is created in which air (that is cooler than inside the baking compartment 30) is taken from the exterior of the baking compartment 30 to the interior thereof by the driving of the fan 17, the air inside the baking compartment 30 (heated by frictional heat) is exhausted to the exterior of the body 10, and the interior of the baking compartment 30 is cooled.

The number and position of the first ventilation holes 32 and the second ventilation holes 33 shall not be construed to be limited to the configuration of the present embodiment. The number and position may be suitably modified so that the bread container 80 accommodated in the baking compartment 30 can be cooled with good efficiency. In the present embodiment, the positions in which the first ventilation holes 32 and the second ventilation holes 33 are formed are the mutually opposing sidewalls 30bf, 30bb. A configuration is thereby adopted wherein an intake port (first ventilation holes 32) and an exhaust port (second ventilation holes 33) are provided so that the bread container 80 accommodated inside the baking compartment 30 is disposed therebetween, and the bread container 80 can be cooled with good efficiency by the airflow created by the fan 17.

In the automatic bread maker 1 of the present embodiment, the first ventilation holes 32 and the second ventilation holes 33 are obtained by performing work in which parts of the sidewalls 30bf, 30bb are made to protrude in a direction facing the exterior of the baking compartment 30. However, the present invention shall not be construed to be limited to this configuration. For example, the first ventilation holes 32 and the second ventilation holes 33 may obtained by performing work in which parts of the sidewalls 30bf, 30bb are made to protrude in a direction facing the interior of the baking compartment 30. However, the configuration of the present embodiment is preferred in that it is possible obtain a structure in which foreign matter is less liable to enter into the duct 16 and the interior of the body 10 from the baking compartment 30. The configuration of the present embodiment is preferred in that there are no projections inside the baking compartment 30, and there will be little incidence of matter getting caught or other such events occurring inside the baking compartment 30. The first ventilation holes 32 and the second ventilation holes 33 may be holes opened by a drill or the like in the sidewalls 30bf, 30bb.

In the automatic bread maker 1 of the present embodiment, a fan 17 is provided inside the duct 16, but it is apparent that a cooling fan can also be mounted to the exterior of one end of the duct 16.

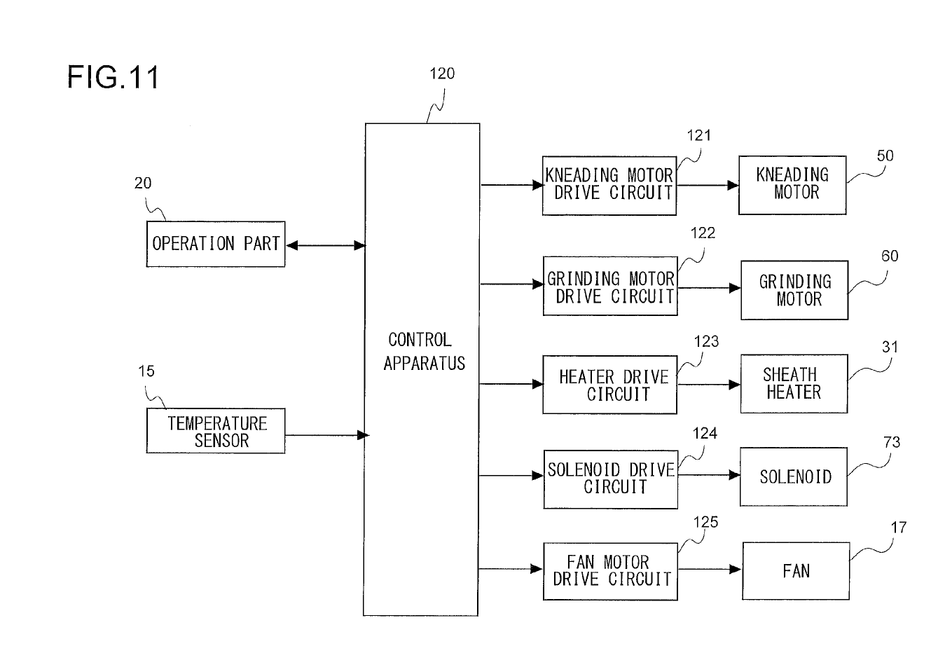

FIG. 11 is a block diagram showing the configuration of the automatic bread maker of the present embodiment. A control apparatus 120 controls the operation of the automatic bread maker 1, as shown in FIG. 11. The control apparatus 120 is configured using, for example, a microcomputer composed of a central processing unit (CPU), read only memory (ROM), random access memory (RAM), input/output (I/O) circuitry, and other components. The control apparatus 120 is preferably disposed in a position unlikely to be affected by the heat of the baking compartment 30. Further, the control apparatus 120 comprises a time measurement function, making it possible to perform time control in the bread-making step. The control apparatus 120 is an embodiment of the control unit of the present invention.

Electrically connected to the control apparatus 120 are the above-described operation part 20, a temperature sensor 15 for detecting the temperature of the baking compartment 30, a kneading motor drive circuit 121, a grinding motor drive circuit 122, a heater drive circuit 123, a solenoid drive circuit 124, and a fan motor drive circuit 125.

The kneading motor drive circuit 121 is a circuit for controlling the driving of the kneading motor 50 under instruction from the control apparatus 120. The grinding motor drive circuit 122 is a circuit for controlling the driving of the grinding motor 60 under instruction from the control apparatus 120. The heater drive circuit 123 is a circuit for controlling the operation of the sheath heater 31 under instruction from the control apparatus 120. The solenoid drive circuit 124 is a circuit for controlling the driving of the solenoid 73 (refer to FIGS. 3A and 3B) for switching the state of the clutch 56 (refer to FIGS. 3A and 3B) under instruction from the control apparatus 120. The fan motor drive circuit 125 is a circuit for controlling the driving of the fan 17 (refer to FIG. 10) under instruction from the control apparatus 120.

The control apparatus 120 reads a program related to the procedure for making bread (bread-making procedure) stored in ROM or the like on the basis of an input signal from the operation part 20. The control apparatus 120 causes a bread-making procedure to be executed in the automatic bread maker 1 while controlling the rotating of the kneading blade 102 and the complementary kneading blade 103 carried out by the kneading motor 50 via the kneading motor drive circuit 121, controlling the rotating of the grinding blade 90 carried out by the grinding motor 60 via the grinding motor drive circuit 122, controlling the heating operation carried out by the sheath heater 31 via the heater drive circuit 123, controlling the switching of the clutch 56 by the solenoid 73 via the solenoid drive circuit 124, and controlling the cooling operation by the fan 17 via the fan motor drive circuit 125.

[Operation of the Automatic Bread Maker]

Next, the operation of the automatic bread maker 1 will be described for the case in which bread is made by the automatic bread maker 1 configured in the manner described above. Here, the operation of the automatic bread maker 1 will be described using as an example the case in which bread is made by the automatic bread maker 1 using rice grains as a starting ingredient.

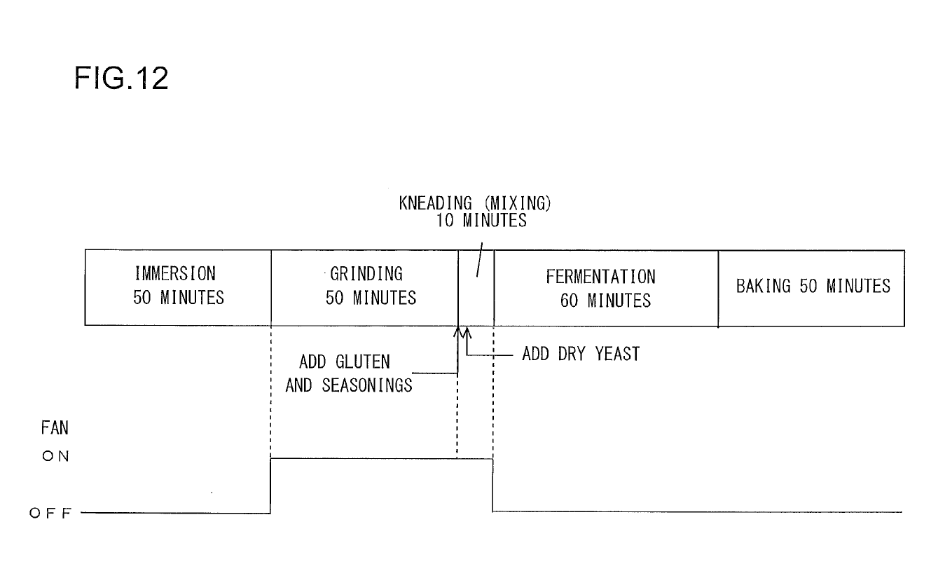

The bread-making procedure for rice grains is selected in the case that rice grains are used as the starting ingredient. FIG. 12 is a schematic view showing the flow of the bread-making steps executed by the rice-grain bread-making procedure. In the rice-grain bread-making procedure, the following steps are sequentially performed in the following order: an immersion step, a grinding step, a kneading (mixing) step, a fermentation step, and a baking step, as shown in FIG. 12. FIG. 12 also shows the operating state of the fan 17 so as to facilitate understanding of the operation of the cooling mechanism for cooling the baking compartment 30.

A user mounts the grinding blade 90 and the cover 100, on which the kneading blade 102 and the complementary kneading blade 103 are attached, on the blade rotation shaft 82 of the bread container 80 when bread is to be made using the rice-grain bread-making procedure. The user then measures the respective predetermined amounts of rice grains and water and puts them in the bread container 80. Here, rice grains and water are mixed, but a liquid having a taste component such as a soup stock, fruit juice, a liquid containing alcohol, or another liquid, for example, may be used in place of plain water. The user inserts the bread container 80, into which the rice grains and water have been put, into the baking compartment 30, closes the lid 40, selects a rice-grain bread-making procedure by operating the operation part 20, and presses the start key. The rice-grain bread-making procedure for making bread using rice grains as a starting ingredient is thereby started by the control apparatus 120.

When the rice-grain bread-making procedure is started, the immersion step is started by instruction from the control apparatus 120. In the immersion step, the mixture of rice grains and water is left in a stationary state, and the stationary state is maintained for a predetermined time (50 minutes in the present embodiment) set in advance. In the immersion step, the rice grains get soaked with water, which is performed to facilitate the grinding of the rice grains to the cores in the grinding step performed subsequently.

The water-absorption speed of the rice grains varies with the water temperature. That is, the water-absorption speed increases with a high water temperature and decreases with a low water temperature. Accordingly, the time of the immersion step may be varied in accordance with, e.g., the ambient temperature in which the automatic bread maker 1 is used and other parameters. Variability in the water absorption of the rice grains can thereby be minimized. It is possible to energize the sheath heater 31 during the immersion step to increase the temperature of the baking compartment 30 in order to shorten the immersion time.

In the immersion step, the grinding blade 90 may be caused to rotate in the initial stage and the grinding blade 90 may be caused to rotate intermittently thereafter. Such a configuration makes it possible to scar the surfaces of the rice grains, improving the liquid-absorption efficiency of the rice grains.

When the above-noted predetermined time has elapsed, the immersion step is ended and the grinding step for grinding the rice grains is started by instruction from the control apparatus 120. In the grinding step, the grinding blade 90 is rotated at high speed in the mixture of rice grains and water. Specifically, the control apparatus 120 controls the grinding motor 60, rotating the blade rotation shaft 82 in the reverse direction and starting the grinding blade 90 rotating in the mixture of rice grains and water.

In the case that the grinding blade 90 is to be rotated using the grinding motor 60, the control apparatus 120 drives the solenoid 73 to cause the clutch 56 to cut off power (the state shown in FIG. 3A). As described above, the motor may be damaged if this control is not performed. The control apparatus 120 drives the fan 17 when the grinding step is started (refer to FIG. 12). This is performed to prevent the temperature of the bread ingredients (cereal grains (flour) and water) in the bread container 80 from increasing excessively in the grinding step.

In the case that the blade rotation shaft 82 has been caused to rotate in the reverse direction in order to cause the grinding blade 90 to rotate, the cover 100 also begins to rotate in accompaniment with the rotation of the blade rotation shaft 82; however, the rotation of the cover 100 will be immediately inhibited by an operation such as that described below. The rotation direction of the cover 100 accompanying the rotation of the blade rotation shaft 82 for rotating the grinding blade 90 is clockwise in FIG. 7, and, in a case that the kneading blade 102 has been in the folded orientation (the orientation shown in FIG. 7), the kneading blade 102 is changed to the open orientation (the orientation shown in FIG. 8) by resistance from the mixture of the rice grains and water. When the kneading blade 102 moves to the open orientation, the second engaging body 104b departs from the rotation trajectory of the first engaging body 104a, and therefore the cover clutch 104 disconnects the blade rotation shaft 82 from the cover 100. At the same time, the kneading blade 102 in the open orientation hits the inner wall of the bread container 80 as shown in FIG. 8, inhibiting the rotation of the cover 100.

In the grinding step, the rice grains are ground in a state in which water has permeated the rice grains by the preceding immersion step, and therefore the rice grains can be readily ground to their cores. Rotation of the grinding blade 90 in the grinding step is intermittent in the present embodiment. This intermittent rotation is performed, e.g., in a cycle in which rotation occurs for 30 seconds and is stopped for five minutes, and the cycle is repeated 10 times. In the final cycle, the five-minute stoppages are not performed. The rotation of the grinding blade 90 may be continuous, but intermittent rotation is preferred in order, e.g., to prevent the temperature of the ingredients in the bread container 80 from becoming excessively high, and for other purposes.

The possibility that rice grains will fly out of the bread container 80 in the grinding step is low because grinding is carried out inside the cover 100. The rice grains that enter into the cover 100 from the aperture part 114 of the guard 110, which is not rotating, are sheared between the rotating grinding blade 90 and the stationary spokes 113 and are therefore ground with good efficiency. Also, the rice grains are ground with good efficiency because the flow (flow in the same direction as the rotation of the grinding blade 90) of the rice-grain and water mixture is minimized by the ribs 106 provided to the cover 100.

The ground rice-grain and water mixture is guided by the ribs 106 in the direction of the windows 105 and discharged from the windows 105 to the exterior of the cover 100. The mixture is unlikely to pool on the surface of the ribs 106 and the mixture smoothly flows toward the windows 105 because the ribs 106 are curved so that the side facing the mixture, which is pressing against the ribs, is convex. The mixture present in the space above the recess 81 furthermore enters into the recess 81, passes from the recess 81 through the aperture part 114 of the guard 110, and enters into the cover 100 to replace the mixture that has been discharged from the interior of the cover 100. Grinding by the grinding blade 90 is carried out under the formation of such an environment so grinding can be achieved with good efficiency.

In the automatic bread maker 1, the control apparatus 120 controls the driving of the fan 17 so that an effective cooling effect can be obtained in the case that the grinding step is executed. Accordingly, it is possible to inhibit an excessive increase in the temperature of the bread ingredients in the bread container 80.

The grinding step is ended in a predetermined length of time in the automatic bread maker 1 (50 minutes in the present embodiment). However, the hardness of the rice grains may vary, and the granularity of the ground flour may vary depending on ambient conditions. Therefore, it is possible to configure the automatic bread maker 1 so that the magnitude of the load on the grinding motor 60 during grinding (which can be determined by, e.g., the control current or the like of the motor) is used as an indicator for determining the end of the grinding step.

Upon completion of the grinding step, a kneading step is subsequently performed. The kneading step must be performed at a temperature (e.g., about 30° C.) at which the yeast can actively work. It is therefore preferred that the kneading step be started when the temperature (measured directly or indirectly) of the ingredients inside the bread container 80 has reached a predetermined temperature range. As described above, the temperature of the bread ingredients does not increase excessively and the kneading step can be smoothly started because the fan 17 is driven during the grinding step in the automatic bread maker 1.

At the start of the kneading step, gluten, as well as seasonings such as salt, sugar, and shortening are fed into the bread container 80 by the respective amounts. These bread ingredients may be fed, for example, manually by the user, or automatically by providing an automatic feeding apparatus that will free the user from this task.

Gluten is not an essential bread ingredient. Gluten can therefore be added to the bread ingredients as deemed necessary by the user. A wheat flour or a thickening stabilizer (e.g., guar gum) may be fed together with gluten or in place of gluten. The amount of seasonings such as salt, sugar, and shortening may be suitably modified in accordance with the preference of the user.

At the start of the kneading step, the control apparatus 120 drives the solenoid 73 so that the clutch 56 transmits power (the state shown in FIG. 3B). In the automatic bread maker 1, the control apparatus 120 also drives the fan 17 (refer to FIG. 12) in the kneading step subsequent to the grinding step. This is done to inhibit a situation in which the temperature inside the baking compartment 30 increases due, inter alia, to the rotation of the kneading motor 50 in the kneading step, and the temperature of the bread ingredients departs from a desired temperature (a desired temperature for allowing the yeast to actively work, e.g., about 30°).

When the control apparatus 120 controls the kneading blade 50 and causes the blade rotation shaft 82 to rotate in the forward direction, the grinding blade 90 also rotates in the forward direction and the bread ingredients around the grinding blade 90 flow in the forward direction. When the cover 100 moves in the forward direction (the counter-clockwise direction in FIG. 8) in accompaniment therewith, the kneading blade 102 undergoes resistance from the bread ingredients that are not flowing and changes angle from an open orientation (refer to FIG. 8) to a folded orientation (refer to FIG. 7). When the second engaging body 104b reaches an angle that interferes with the rotation trajectory of the first engaging body 104a, the cover clutch 104 engages and the cover 100 is set at an attitude at which it is fully driven by the rotation of the blade rotation shaft 82. The cover 100 and the kneading blade 102 in the folded orientation both rotate in the forward direction together with the blade rotation shaft 82.

As described above, when the kneading blade 102 is in the folded orientation, the complementary kneading blade 103 aligns along the extension of the kneading blade 102 as if to enlarge the kneading blade 102, and the bread ingredients are forcibly pressed. The dough can therefore be thoroughly kneaded.

The rotation of the kneading blade 102 and the complementary kneading blade 103 in the kneading step may be continuous from beginning to end, but in the automatic bread maker 1, the rotation is intermittent in the initial stage of the kneading step and is continuous in the latter half of the kneading step. In the present embodiment, yeast (e.g., dry yeast) is fed at the stage where the intermittent rotation carried out initially has ended. The yeast may be fed by the user, or may be automatically fed. The reason for not feeding the yeast with the gluten or the like is to prevent the yeast from coming into direct contact with water as much as possible. Depending on the situation, the yeast, gluten and the like may be fed simultaneously.

The bread ingredients are mixed and kneaded by the rotation of the kneading blade 102 and the complementary kneading blade 103 to become an integrated ball of dough having a prescribed elasticity. The kneading blade 102 and the complementary kneading blade 103 toss the dough about and beat it against the inner wall of the bread container 80, adding the element of “kneading” to the mixing. The cover 100 also rotates together with the kneading blade 102 and the complementary kneading blade 103. When the cover 100 rotates, the ribs 106 formed on the cover 100 also rotate, and the bread ingredients inside the cover 100 are rapidly discharged from the windows 105. The discharged bread ingredients are assimilated into the mass (dough) of bread ingredients being kneaded by the kneading blade 102 and the complementary kneading blade 103.

In the kneading step, the guard 110 also rotates in the forward direction together with the cover 100. The spokes 113 of the guard 110 are shaped so that the center side of the guard 110 leads and the external peripheral side of the guard 110 trails during forward rotation. For this reason, the guard 110 rotates in the forward direction, whereby the bread ingredients inside and outside the cover 100 are pressed outward with the aid of the spokes 113. The ratio of starting material discarded after the bread has been baked can thereby be reduced.

The bread ingredients at the periphery of the cover 100 are thrown upward at the front surface of the columns 115 during kneading because the columns 115 of the guard 110 are configured so that the side surfaces 115b (refer to FIG. 9) are sloped upward, the side surfaces 115b being the front surface in the direction of rotation when the guard 110 rotates in the forward direction. The ratio of starting material that is discarded after the bread has been baked can therefore be reduced.

In the automatic bread maker 1, the time for the kneading step may be a predetermined time (10 minutes in the present embodiment) obtained by experimentation as the time required to obtain a bread dough having desired elasticity. However, when the time for the kneading step is fixed, the quality of the bread dough may vary due to ambient temperature or another factor. Therefore, it is possible to use a configuration in which, e.g., the magnitude of the load on the kneading motor 50 (which can be determined by, e.g., the control current or the like of the motor) is used as an indicator for determining the end time of the kneading step.

When bread containing additional ingredients (e.g., raisins, nuts, and cheese) is baked, the additional ingredients can be fed during the kneading step.

When the kneading step is ended, a fermentation step is started according to an instruction from the control apparatus 120. When the fermentation step is started, the control apparatus 120 stops the drive of the fan 17 and thereafter does not allow the fan 17 to be driven until the bread is baked. In the fermentation step, the control apparatus 120 controls the sheath heater 31 and keeps the temperature of the baking compartment 30 to a temperature (e.g., 38° C.) that facilitates fermentation. The bread dough is left standing for a predetermined time (60 minutes in the present embodiment) in an environment that facilitates fermentation.

Depending on the situation, a process such as causing the kneading blade 102 and the complementary kneading blade 103 to rotate, and causing the dough to deflate or become rounded may be performed during the fermentation step.

When the fermentation step is ended, a baking step is started by an instruction from the control apparatus 120. The control apparatus 120 controls the sheath heater 31 and increases the temperature of the baking compartment 30 to a temperature (e.g., 125° C.) suitable for baking bread. The bread is baked for a predetermined time (50 minutes in the present embodiment) in a baking environment. The user is notified of the end of the baking step by, e.g., a display on a liquid crystal display panel of the operation part 20, an audio alert, or the like. When the bread-making is detected to be complete, the user opens the lid 40 and removes the bread container 80 to complete the bread making.

Bake marks of the kneading blade 102 and the complementary kneading blade 103 remain in the bottom of the bread, but since the cover 100 and the guard 110 are accommodated in the recess 81, large bake marks are not left in the bottom of the bread. It is also possible to use a configuration in which the fan 17 is driven by the control apparatus 120 to cool the bread container 80 at a stage when the baking step has ended.

### Other Embodiments

The embodiment indicated above is an example of the present invention, but the configuration of an automatic bread maker in which the present invention is applied is not limited by the embodiments indicated above.

For example, in the embodiment indicated above, a configuration is adopted wherein the control apparatus 120 causes the fan 17 to be driven during the grinding and kneading steps. However, the present invention shall not be construed to be limited to this configuration, and it is possible to use a configuration in which, e.g., the control apparatus 120 causes the fan 17 to be driven only during the grinding step, or another configuration may be used. During bread making, the temperature of the baking compartment 30 may be detected using a temperature sensor 15 (an embodiment of the temperature detector of the present invention; refer to FIG. 11), and the drive of the fan 17 may be controlled on the basis of the temperature thus detected. Such control is effective because the manner in which the temperature of the ingredients inside the bread container 80 accommodated in the baking compartment 30 changes will vary depending on fluctuation in the ambient temperature of the automatic bread maker 1.

In the embodiment described above, a configuration is adopted in which the fan 17 is automatically controlled by the control apparatus 120. However, the present invention is not limited to this configuration; it is also possible to use a configuration in which, e.g., the fan 17 is driven with the preferred timing of the user using a switch provided to the body 10, or another configuration may be used.

In the embodiment described above, the cooling mechanism was configured using a fan 17 of a type that draws out air from the baking compartment 30, but the present invention shall not be construed to be limited thereby. In other words, it is also possible to use a configuration in which the cooling mechanism for cooling the baking compartment 30 is configured using a fan of a type that blows air from the exterior into the baking compartment 30.

Described above is the case in which bread is made by the automatic bread maker using rice grains as a starting ingredient, but the automatic bread maker of the present embodiment can make bread using, e.g., wheat flour or rice flour as a starting ingredient. The grinding blade 90 is not required in the case that wheat flour or rice flour is used as the starting ingredient, and it is therefore possible to use a bread container (a conventional bread container in which only a kneading blade is mounted on the blade rotation shaft) that is different from the one indicated above.

In the case that a cereal flour (milled flour) such as wheat flour or rice flour is used as the starting ingredient, the control apparatus 120 executes bread-making steps that include a kneading step for causing the kneading blade to rotate and knead bread dough inside the bread container into which cereal flour and, e.g., yeast (dry yeast or the like), seasonings (salt, sugar, shortening or the like), gluten, guar gum or another thickener, and other bread ingredients have been put; a fermentation step for allowing the kneaded bread dough to ferment; and a baking step for baking the fermented bread dough. Gluten and thickener are not necessarily required and may be added as required. Gluten and thickener are often used in the case that rice flour is used as the cereal flour. In the fermentation step, a gas-purging step for purging gas from the bread dough, or a rounding step for rounding the bread dough may be suitably performed. In the case that such bread-making steps are to be executed, the control apparatus 120 may control the drive of the fan 17 on the basis of temperature information from the temperature sensor 15 for detecting the temperature of the baking compartment 30. For example, the temperature of the baking compartment 30 may at times increase above a desired temperature in each step during the summer season and result in poor-quality bread. However, the fan 17 can be suitably driven on the basis of the temperature information (such control is effective in, e.g., the kneading step), whereby the effect of the ambient temperature can be inhibited and good quality bread can be made.

In the embodiments described above, the configuration and operation of the automatic bread maker were described using an example in which rice grains are used as the starting ingredient. However, the automatic bread maker of the present invention may also be applied to the case in which, e.g., wheat, barley, millet, Japanese millet, buckwheat, corn, soy beans, or other cereal grains other than rice grains are used as the starting ingredient.

The bread-making steps carried out in the above-described rice-grain bread-making procedure are merely examples, and other steps may be employed. Another example is to carry out the immersion step again and thereafter carry out the kneading step in order to cause the ground flour to absorb the water after the grinding step.

### Industrial Applicability

The present invention is suitably used in an automatic bread maker for household use.

### List of Reference Signs

1 automatic bread maker

10 body

15 temperature sensor (temperature detector)

16 duct

17 fan

30 baking compartment (accommodation part)

30b sidewall of the baking compartment (sidewall of the accommodation part)

30bf front sidewall of the baking compartment (first sidewall)

30bb rear sidewall of the baking compartment (second sidewall)

31 sheath heater (heating part)

32 first ventilation holes

33 second ventilation holes

50 kneading motor (second motor)

60 grinding motor (first motor)

80 bread container

90 grinding blade

102 kneading blade

103 complementary kneading blade

120 control apparatus (control unit)

1. An automatic bread maker comprising:
a bread container into which bread ingredients are put;
a body having an accommodation part for accommodating the bread container;
a grinding blade for grinding cereal grains inside the bread container accommodated in the accommodation part; and
a duct and fan for creating an airflow cooling the accommodation part using ventilation holes provided in the accommodation part.

2. The automatic bread maker of claim 1, further comprising a first motor provided inside the body in order to cause the grinding blade to rotate.

3. The automatic bread maker of claim 2, wherein
further comprising a control unit for executing bread-making steps, the bread-making steps including a grinding step for causing the grinding blade to rotate and grind cereal grains inside the bread container into which cereal grains and a liquid have been put, wherein
the control unit drives the fan in the case that the grinding step is executed.

4. The automatic bread maker of claim 2, further comprising:
a kneading blade for kneading bread ingredients into bread dough inside the bread container accommodated in the accommodation part;
a second motor provided inside the body in order to cause the kneading blade to rotate;
a heating part provided to the accommodation part; and
a control unit for causing bread-making steps to be executed, the bread-making steps including a grinding step for causing the grinding blade to rotate and grind cereal grains inside the bread container into which cereal grains and a liquid have been put, a kneading step for causing the kneading blade to rotate and knead bread dough inside the bread container into which bread ingredients including ground flour obtained by grinding cereal grains have been put, a fermentation step for causing kneaded bread dough to ferment, and a baking step for baking fermented bread dough, wherein
the control unit drives the fan in the case that at least the grinding step of the bread-making steps is executed.

5. The automatic bread maker of claim 1, further comprising
a temperature detector for detecting the temperature of the accommodation part; and
a control unit for controlling drive of the fan on the basis of temperature information obtained from the temperature detector.

6. The automatic bread maker of claim 1, wherein the ventilation holes are formed so that a part of a sidewall of the accommodation part is made to protrude in a direction facing the exterior of the accommodation part.

7. The automatic bread maker of claim 1, wherein
first ventilation holes and second ventilation holes are included in the ventilation holes provided to the accommodation part;
the accommodation part and the exterior of the body are in communication via the duct and the second ventilation holes; and
the fan takes air from the exterior of the accommodation part into the accommodation part via the first ventilation holes, and exhausts air inside the accommodation part to the exterior of the body via the second ventilation holes and the duct.

8. The automatic bread maker of claim 7, wherein the first ventilation holes are formed in a first sidewall of the accommodation part, the second ventilation holes are formed in a second sidewall of the accommodation part, and the first sidewall and the second sidewall face each other.

9. The automatic bread maker of claim 1, wherein the fan is provided inside the duct.
